(19) United States
(12) Patent Application Publication
(10) Pub. No.: US 2021/0204554 A1
(43) Pub. Date: Jul. 8, 2021

(54) PACKING FRUITS IN PLASTIC CANS

(71) Applicant: DEL MONTE PHILIPPINES, INC., Bonifacio Global City, Taguig City (PH)

(72) Inventors: Ma. Bella B. JAVIER, Taguig City (PH); Jose Rodeo D. FEROLIN, Taguig City (PH); Vilma L. LUNA, Taguig City (PH); Ma. Theresa P. CORONIA, Taguig City (PH); Charmine A. CAPAGNGAN, Taguig City (PH); Alan SALCEDO, Taguig City (PH)

(73) Assignee: Del Monte Philippines, Inc., Bonifacio Global City, Taguig City (PH)

(21) Appl. No.: 15/777,617

(22) PCT Filed: Nov. 26, 2015
(86) PCT No.: PCT/PH2015/000018

§ 371 Date: May 18, 2018

(51) Int. Cl. A23B 7/005; B65B 7/28; B65B 55/00; B65B 25/04; B65B 3/28; B65B 31/02; B65B 31/00; A23B 7/148

(52) U.S. Cl. CPC A23B 7/0056; B65B 7/2842; B65B 55/00; B65B 25/041; A23V 2002/00; B65B 31/028; B65B 31/006; A23B 7/148; B65B 2220/24; B65B 3/28

(57) ABSTRACT

The present invention discloses a new method of packing and preserving fruits in liquid (fruit juice, syrup, water, etc). The method comprises packaging fruits, where the fruit is filled into a specifically formulated plastic container, topped with liquid, dosed with inert gases to enforce can integrity, seamed with metal can ends, and thermally processed to eliminate viable microorganisms. The process is unique in that by adjusting thermal processing parameters and manipulating the seam specifications, replacing the metal cans by a flexible and sustainable plastic can, becomes a practical alternative.

### FIELD OF THE INVENTION

The present invention discloses a method of preserving and packaging fruits using a plastic container with metal closures. This introduces a new and differentiated container format: fruits packaged in ‘plastic cans’ and processed from existing downstream conventional canning facility used for metal cans.

### BACKGROUND OF THE INVENTION

Most processed fruits are typically packed in metal cans. Metal cans normally have easy open or sanitary closures. Other containers used are plastic cups, flexible pouches, etc. Consumers have associated metal cans with durability, long shelf life and safety. Plastics and flexibles are seen as convenient because they are renewable (sustainable), structurally less complicated than metal cans, more affordable for consumers and consumers can see the product in the container. Plastic containers are also lighter than their metal counterpart.

The opportunity to combine plastics with specific structured material as container, and hermetically sealed with metal can ends could provide a product format that is unique and can also meet the consumers' need for quality and safe preserved fruit products.

The traditional process of double seaming and pasteurizing the contents for food safety has the challenge of molding the plastic material into the metal closure for hermetic seal. Issues encountered during the process are paneling, heavy wrinkles and loose cover hook, which may eventually result to product leakage and sporadic product spoilage.

This present invention aims to provide a process of integrating the plastic can in the process of packing of fruits and yet using the same canning infrastructure for metal cans.

### SUMMARY OF THE INVENTION

It is the objective of this invention to produce an acceptable fruits product packed in an affordable plastic container.

It is a further objective of this invention to present a method of thermally processing plastic containers superior (affordable, ease of processing, sustaining product quality, etc.) to metal containers.

Suitable processing conditions are designed (such as packaging liquid composition, pH, temperature and time of processing, pressure, etc) and chosen to accommodate utilizing plastic container. These conditions are controlled to ensure the product complies with Good Manufacturing Practices (GMP) set by the regulatory agencies and consumer acceptance. Further, the controlled conditions eliminate the buckling and paneling of the plastic cans.

Controlled conditions include monitoring fill weights and headspace accurately. When adequate fruit and packing medium is filled into the plastic container, enough headspace is achieved. Adequate headspace is required for gas expansion during heating to avoid potential sealing issues due to bulging of package. Too much headspace, on the other hand, creates a negative pressure within the container when the sealed package is cooled. During the heating-cooling process, the air in the headspace contracts and the negative pressure causes the side panels to collapse inward due to reduction of the initial internal can pressure.

Filling temperature and fruit to juice ratio are also maintained at a certain range. Dosing of gases before can closing is also employed at a specified pressure. This helps in reducing headspace/air in the package and in strengthening package during seaming compression and changes in pressure during the thermal process.

It is also essential that the seamer parameters are set correctly. Critical seaming settings such as seam thickness, overlap and seam compression are maintained as such to ensure preserving product integrity. With plastics having lower tolerance to changes in pressure, heating and cooling temperatures and cooker pressure are also controlled to avoid high pressure differentials that may cause container deformation or panelling.

All of the preceding aspects in all of their related embodiments that can be described as illustrative within the skill of the relevant art are also included within the true spirit and scope of the present invention.

### BRIEF DESCRIPTION OF THE DRAWINGS

FIG. 1 is a flow diagram illustrating the process of the present invention as it applies to fruits.

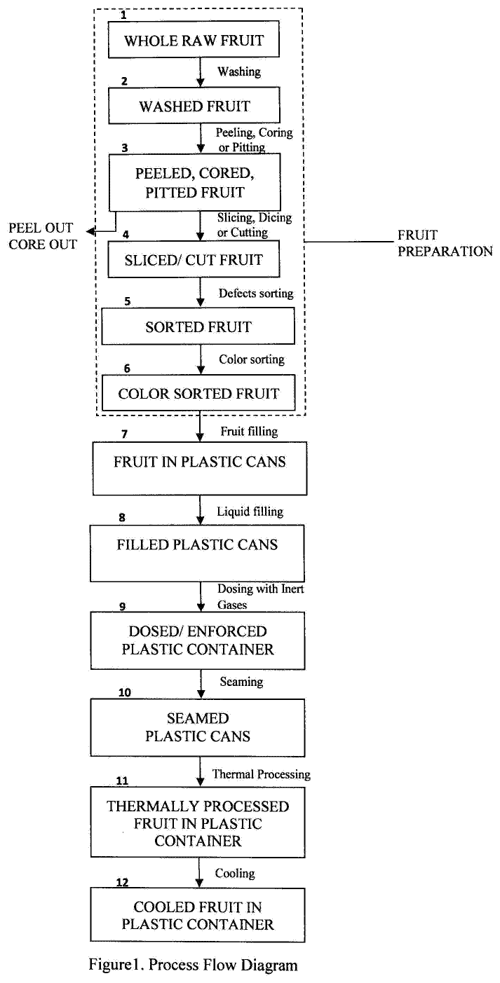

### DETAILED DESCRIPTION OF THE INVENTION

The present invention relates to an, alternative method of processing fruits by packing them in plastic containers instead of traditional metal containers. In a preferred embodiment, metal containers to process fruits are replaced by plastic containers specifically in plastic cans.

Referring to FIG. One, one embodiment of a process incorporates the present invention in which fruits are packed and processed in plastic cans.

Steps 1 through 6 are the preparation steps in which the fruit is being peeled, cored, pitted, etc. Fruits are cut, sliced, diced, etc using conventional methods, and sorted for defects and color.

In Steps 7 through 8, the fruits or liquid is placed into empty plastic cans first using known conventional methods. Fruit to liquid ratio is maintained at a range of 10% to 90% fruit and 90% to 10% for the liquid syrup. Fruits could be tropical or non tropical fruits, and or deciduous or aciduous fruits. Fruits are selected from but not limited to pineapple, apple, banana, blueberries, cherries, coconut, grapes, guava, jackfruit, kiwi, lychee, longan, mangoes, mangosteen, oranges, papaya, passionfruit, pears, pomegranate, raspberries, strawberries, soursop, etc. singly and or in combination thereafter.

The liquid medium may contain juices, water, carbohydrates (mono, di or oligosaccharides), non-nutritive sweeteners (natural or artificial, and or combination of), fruit and vegetable purees, sauces, flavors, acids (organic or inorganic), and other food additives, singly and or in combination of. The sugars are added in the solution in amounts to achieve a ° Brix range of 8° B-60° B, preferably from 10° B to 22° B.

Acidulants are used to acidify and adjust pH within 2.0 to 6.0, preferably from 3.0 to 4.0. Food additives may include but not limited to antioxidants such as ascorbic acid, natural and artificial flavors, natural and artificial colors, or combination of, natural and artificial preservatives or combination of. This is as opposed to standards of pineapple in metal cans where ingredients are restricted to sugars, juices, citric acid and flavors. A particular advantage of the plastic can is the flexibility to add other ingredients, especially the addition of antioxidants or anti-browning agents to protect color and flavor of the product.

Antioxidants are selected but not limited from the groups consisting of ascorbic acid, tocopherols, ascorbyl palmitate, erythorbates, erythorbic acid, Butylated. Hydroxyanisole (BHA), sodium ascorbate, singly or in combination thereof. The packing medium can further composed of food grade additives such as stabilizers, nutrient fortificants such as vitamins and minerals, and processing aids such as defoamers, clarifying agents, catalysts, flocculating agents, enzymes and coagulants.

To protect the product and container integrity during the process, the following steps are initiated; (a) weight of fruit and packing medium is controlled and kept at a range that achieves a headspace of 3.0 mm to 15.0 mm from the top of the container to the surface of the fruit or liquid in the container, preferably from 4.0 mm to 10 mm, (b) filling temperature of packing medium ranges from 30° C. to 70° C., preferably from 35° C. to 50° C., (c) seamer settings and double seaming parameters are set correctly, (d) dosing of filled plastic cans with inert gas such as but not limited to nitrogen gas, at a dosing pressure ranging from 0.1 psi to 50.0 psi, preferably from 5.0 psi to 30.0 psi.

In Step 9, the plastic cans are dosed with inert gases such as but not limited to nitrogen and or in combination with carbon dioxide, to enforce can integrity.

In Step 10, the plastic cans are seamed with metal sanitary ends or easy open metal closures via a double seamer to achieve hermetic seal. The double seamer is set up generally according to plastic can size, can material and type of metal closure. Generally, the critical seaming parameters for seamer set-up are the Overlap, Seam Thickness and Seam Compression. The degree of interlocking of the body hook and cover hook of the can is known as the overlap. The Overlap is set at a range of 0.3 mm to 5.0 mm, preferably from 0.4 mm to 3.0 mm. Seam thickness is set from 0.1 mm to 10.0 mm, preferably from 0.5 mm to 5.0 mm. Seam compression is the degree of tightness of the seaming. This is measured as the degree of the wrinkle rating at the end of a can's cover hook and is set at 0%-20%, preferably from 3%-15%.

Step 11 is the heating step, where the seamed plastic cans are conveyed to the cooker, such as but not limited to a retort or a pasteurizer. For the thermal processing, temperature ranges from 50° C. to 150° C., preferably at 65° C.-100° C. The product may be heated for about 5 minutes to 1 hour, preferably 10 to 40 minutes. Retort pressure is kept at 1.0 psi to 50.0 psi preferably from 5.0 psi to 30.0 psi.

Step 12 describes the cooling of the product in package. The cooling temperature may range from 1° C. to 40° C., preferably 2° C. to 35° C. Cooling time may range from 0.5 minutes to 1 hour, preferably 10 to 40 minutes. Retort pressure is kept at a range of 0.01 psi to 15.0 psi, preferably from 0.05 psi to 5.0 psi.

The resulting product is a hermetically sealed and processed fruit packed in plastic cans.

It is understood that the embodiment of the present invention which has been described is illustrative of one of the application of the present invention. Numerous modifications may be made by those skilled in the art without departing from the true spirit and scope of the invention.

The following example will further explain the invention in more detail, to which it is not limited.

The following examples describe the nature of the invention.

### Example 1

The fresh pineapple fruit is washed with water, graded, inspected for foreign objectionable materials, peeled, cored, sliced and or cut into pieces, and sorted for defects and color. The pineapple pieces are then filled into pre-washed empty plastic can containers at about 255 grams fill weight. The fruit-filled plastic cans are topped with packing medium composed of pineapple juice with ascorbic acid and citric acid. The package is comprised of around 60% pineapple and 40% pineapple juice mixture.

As shown in table below, about 255 grams of pineapple pieces is filled into the plastic cans and topped with around 170 grams of pineapple juice mixture.

| Pack Fill Ingredients | Weight (gr) | Weight % |
|---|---|---|
| Pineapple | 255.0 | 60.00 |
| Pineapple Juice | 169.3 | 39.83 |
| Ascorbic acid | 0.5 | 0.12 |
| Citric acid | 0.2 | 0.05 |
| Total | 425.0 | 100.00 |

At this package composition, a target headspace of 5.0 mm is achieved. Fill weight and headspace parameters should, be controlled to avoid container deformation due to thermal expansion and contraction of the can contents during the thermal processing procedure.

Citric acid is added to adjust the pH of the product while ascorbic acid is added to protect color and flavor. pH is adjusted to less than 3.90. Titratable acidity is about 0.2 grams citric acid per 100 grams. This juice mixture is heated and filled into the plastic cans at a filling temperature of 60° C. to 90° C.

The filled plastic cans are dosed with nitrogen to strengthen can integrity. These are then seamed, ensuring that there are no visual double seam defects such as “false seams”, “dead heads”, etc. Seamed samples are subjected to visual and optical seam inspection and tear down analysis to measure critical parameters for double seam integrity. Critical double seam parameters include seam thickness, overlap and seam compression measurements. For a 425 gram capacity package, seam thickness is set at 1.60 mm to 2.70 mm. Overlap is set at a minimum of 0.70 mm. Seam compression is kept at 10%-15%.

The seamed cans are transferred into a retortand are thermally processed. The cans are retorted at about 90° C. for about 25 minutes. Retort pressure is kept around 9.0 psi to 10.0 psi. The product is then cooled at about 15° C. for about 30 minutes, at a retort pressure variant from 1.0 psi to 4.0 psi.

### Example 2

Peaches are washed with water, peeled, pitted, cut into dices and sorted for defects and color. A 856 grams package contains around 69 to 31 percent fruit to liquid ratio. As shown in the table below, about 591 grams of diced peaches is filled into clean plastic cans.

| Pack Fill Ingredients | Weight (gr) | Weight % |
|---|---|---|
| Peaches | 591.0 | 69.04 |
| Water | 225.1 | 26.30 |
| Sugar | 38.7 | 4.52 |
| Ascorbic acid | 0.7 | 0.08 |
| Citric acid | 0.5 | 0.06 |
| Total | 856.0 | 100.00 |

A mixture of water, sugar, and ascorbic acid as liquid packing medium is previously prepared and heated. The sugar is added in the solution in amounts to achieve a ° Brix of 15.0. Citric acid is added to keep pH within 3.0 to 3.9 while Ascorbic acid is added to protect color and flavor.

The fruit-filled plastic cans are topped with the heated liquid packing medium at a filling temperature of 70° C. to 90° C. and dosed with nitrogen gas at around 10.0 psi. These cans are then seamed with metal can ends. Visual inspection of the seamed sample cans should have a seam thickness of 1.4 mm to 1.6 mm, overlap at a minimum of 1.0 mm and seam compression of about 15.00%. With correct settings for first and second seam operation, target finished double seam dimensions are achieved. These parameters are very important to achieve hermetic seal.

The seamed plastic cans are then conveyed to a pasteurizer and heated at about 90° C.-100° C. for about 30 minutes. Pasteurizer pressure is controlled at around 9.0 psi-10.0 psi. The plastic cans are then cooled at a cooling temperature of about 20° C. for about 20 minutes with a retort pressure of 1.0 psi to 4.0 psi.

### Example 3

Fresh batch of raspberries are washed and stems are removed. The washed fruits are sorted for defects and color.

For a product with a 68% to 32% fruit to liquid ratio, 289.0 grams of sorted raspberries are weighed and then filled into each clean plastic can.

| Pack Fill Ingredients | Weight (gr) | Weight % |
|---|---|---|
| Raspberries | 289.0 | 68.00 |
| Water | 96.3 | 22.66 |
| Sugar | 38.4 | 9.04 |
| Citric acid | 0.9 | 0.21 |
| Ascorbic acid | 0.4 | 0.09 |
| Total | 425.0 | 100.00 |

Around 136.0 grams of a mixture of water, sugar, citric acid and ascorbic acid is prepared and heated as liquid packing medium. The liquid packing medium has a ° Brix of around 29.0° B. Around 38.4 grams of sugar is added to achieve the target finished product Brix. The liquid is also acidified with around 0.9 grams of citric acid to keep pH less than 4.0. Ascorbic acid of about 0.4 grams is also added as antioxidant.

The heated liquid is filled into the plastic cans at a filling temperature of 60° C. to 85° C. The filled cans are dosed with carbon dioxide at a pressure of about 5.0 psi to 7.0 psi. These are then conveyed to a seaming equipment previously set-up with correct double seaming parameters. Double seamer set-up is specific to plastic can packaging type and size. These cans are then seamed with metal easy open ends. Sample seamed plastic cans should pass the first and second seaming operation specification tests to achieve finished double seam dimensions and hermetic seal.

The seamed plastic cans are then conveyed to a pressure cooker for heating. The seamed plastic cans are heated in a pressure cooker at 98° C.-100° C. for about 15 minutes and at a pressure of 9.0 psi-10.0 psi. The products are then cooled at cooling temperatures ranging from 15° C. for about 20 minutes, with pressure kept at 2.0 psi-3.0 psi. After cooling, the processed raspberries are ready for storage and distribution.

### Example 4

Fresh green beans are washed with water, conveyed to size graders and into snipping machines where tips and stems are cut off. The snipped green beans are sorted for defects and blanched. The blanched beans are filled into empty plastic cans as whole beans. The plastic cans are then filled with hot water and dry salt or with brine solution at a solid-liquid ratio of 85% green beans and 15% brine solution. Brine filling temperature is about 95.0° C. Headspace is kept at 5.0 mm to 7.0 mm. The filled cans are dosed with nitrogen gas at around a pressure of 5.0 psi. The seamed sample cans are submitted for visual and optical seam integrity inspection to ensure that the seamer set-up achieves hermetic sealing. The seamed cans should have a seam thickness of around 1.70 mm to 2.70 mm, overlap at 0.70 mm minimum, and about 10%-15% seam compression to achieve hermetic seal. The filled cans are then seamed, heated at 98.0° C.-120.0° C. for about 40 to 45 minutes and a retort pressure of about 9.0 psi to 11.0 psi. The products are then cooled at cooling temperatures ranging from 15.0° C. to 20.0° C. for about 15 minutes at a pressure of 3.0 psi to 5.0 psi. The processed green beans in plastic cans are ready for labelling and packaging for storage or distribution.

1. A method of preserving and packaging fruits using a plastic container with metal closures comprising the steps of:
(a) filing of fruits and liquid medium into plastic containers at suitable conditions to accommodate use of plastic without container deformation;
(b) seaming of plastic cans with metal closures using double seamer set-up for metal cans set at specified seam specifications to achieve seam integrity and hermetic seal; and
(c) thermally processing the seamed plastic cans in cookers for metal cans at controlled processing parameters to avoid container deformation and panelling.

2. The method in accordance with claim 1, wherein the suitable conditions of filling fruits into plastic cans in step (a) includes controlling fill weights, headspace, filling temperature, liquid-to-juice ratio, pH and dosing of gases to avoid container deformation and to ensure can integrity.

3. The method in accordance with claim 2, wherein the weight of fruits and liquid medium is kept at a range that achieves a headspace of 3.0 mm to 15.0 mm from top of the container to the surface of the fruit or liquid in the container.

4. The method in accordance with claim 2, wherein the filling temperature of packing medium ranges from 30° C. to 70° C., and the pH is kept within the range of 2.0 to 6.0.

5. The method in accordance with claim 2, wherein filled plastic cans are dosed with inert gas, wherein the inert gas comprises at least one of nitrogen gas or carbon dioxide, at a dosing pressure range from 0.1 psi to 50.0 psi (approximately 689.48 Pa to approximately 344,737.86 Pa.

6. The method in accordance with claim 1, wherein the plastic cans are seamed with metal sanitary ends or easy open metal closures via a double seamer to achieve hermetic seal.

7. The method in accordance with claim 6, wherein the double seamer is set up according to critical seaming parameters that can accommodate seaming of plastic cans with metal can ends.

8. The method in accordance with claim 7, wherein the critical seaming parameters for seamer set-up include overlap, seam thickness and seam compression.

9. The method in accordance with claim 8, wherein the overlapping ranges from 0.3 mm to 5.0 mm.

10. The method in accordance with claim 8, wherein the seaming thickness ranges from 0.1 mm to 10 mm.

11. The method in accordance with claim 8, wherein the seaming compression ranges from 0.0% 20%.

12. The method in accordance with claim 1, wherein the seamed plastic cans in step (c) are conveyed to cookers, wherein the cookers comprise at least one of a retort (pressurized) cooker or an atmospheric cooker.

13. The method in accordance with claim 1, wherein the thermal processing parameters to be controlled in step (c) includes the heating temperature and time, cooking pressure, cooling temperature and time and cooling pressure.

14. The method in accordance with claim 13, wherein the heating temperature of the seamed plastic cans ranges from 50° C. to 150° C., and the product is heated for approximately 5 minutes to 1 hour, preferably 10 to 40 minutes.

15. The method in accordance with claim 13, wherein the retort cooking pressure ranges from 1.0 psi to 50.0 psi (approximately 6,894.76 Pa to approximately 344,737.86 Pa).

16. The method in accordance with claim 13, wherein the cooling temperature ranges from 1° C. to 40° C., preferably 2° ° C. to 35° C. and the cooling time ranges from 0.5 minutes to 1 hour.

17. The method in accordance with claim 13, wherein the retort cooling pressure ranges from 0.01 psi to 15.0 psi (approximately 68.95 Pa to approximately 103,421.36 Pa).

18. The method in accordance with claim 12, wherein the seamed and processed plastic cans are stored for labelling and distribution.
